(19) United States
(12) Patent Application Publication
(10) Pub. No.: US 2026/0085157 A1
(43) Pub. Date: Mar. 26, 2026

(54) Metal-backboned polymer and preparation method and use thereof

(71) Applicant: FUDAN UNIVERSITY, Shanghai (CN)

(72) Inventors: Huisheng PENG, Shanghai (CN); Kaiwen ZENG, Shanghai (CN)

(73) Assignee: FUDAN UNIVERSITY, Shanghai (CN)

(21) Appl. No.: 18/992,178

(22) PCT Filed: May 5, 2023
(86) PCT No.: PCT/CN2023/092389

§ 371 Date: Dec. 3, 2025

(30) Foreign Application Priority Data
Nov. 4, 2022 (CN) 2022113778222

(51) Int. Cl. C08G 83/00

(52) U.S. Cl. CPC C08G 83/001

(57) ABSTRACT

Provided is a metal-backboned polymer, as well as the preparation method and use thereof. The polymer includes a main chain and ligands. The main chain is composed of metal atoms connected by chemical bonds, with the following general formula: Mₙ, where n represents the number of repeating units and n is greater than 10, M represents metal atoms and is one or more of the transition metal elements. The metal atoms in the main chain are connected to ligands through coordination bonds. The preparation method of the metal-backboned polymer includes the synthesis of the ligand and the synthesis of the metal-backboned polymer. The metal-backboned polymer of the present disclosure opens up a new avenue to design new functional polymers in the future.

### FIELD OF TECHNOLOGY

The present disclosure relates to the field of polymer materials, particularly to a metal-backboned polymer, and preparation method and use thereof.

### BACKGROUND

In 1920, Hermann Staudinger published a landmark paper titled “On Polymerization” in the Journal of the German Chemical Society, proposing the hypothesis that polymerization is a process in which a vast number of small molecules combine to form macromolecules through chemical bonds. This hypothesis marked the establishment of the discipline of polymer science. By the end of the 1930s, this concept had been gradually accepted by the academic community. Since then, polymer science has experienced rapid development and witnessed a series of significant advances and breakthroughs. Starting in the 1940s, Paul J. Flory proposed the theory of polymer solutions, thereby laying a solid foundation for research in polymer physics. In the 1950s, Karl Ziegler and Giulio Natta developed the coordination polymerization reaction, through which they synthesized isotactic polyethylene and polypropylene. In the 1960s, Robert Bruce Merrifield introduced a solid-phase organic synthesis method for polypeptides. Meanwhile, Pierre-Gilles de Gennes managed to extend the methods used for studying ordered phenomena in simple systems to complex ones like polymers and liquid crystals. Since the 1970s, Alan J. Heeger, Alan G. MacDiarmid, and Hideki Shirakawa have been engaged in the study of conductive polymers and have made pioneering contributions. Robert H. Grubbs proposed a catalyst for the olefin metathesis reaction, which has played an important role in polymer synthesis.

Through the important events in the development of polymer science from its birth to its growth as mentioned above, and looking back on the development course of polymer science over the past 100 years, organic polymers all take non-metallic atoms as the basic components of their main chains. The theories of polymer physics and polymer chemistry have been established on the above basis. However, up to now, metal-backboned polymers have not been reported yet.

### SUMMARY

The present disclosure provides a metal-backboned polymer, as well as preparation method and use thereof. The main chain of the metal-backboned polymer is formed by metal atoms connected through chemical bonds and is prepared through the metallization reaction of ligands. Due to the existence of metal atoms connected by chemical bonds in the polymer's main chain, the polymer may exhibit unique properties in aspects such as light, heat, force, sound, electricity, and magnetism, thereby having potential applications in optoelectronic devices, energy information, biomedical materials, superconducting materials, and other fields.

The present disclosure can be achieved through the following technical solution.

A metal-backboned polymer includes a main chain and at least one ligand. The main chain includes metal atoms connected by chemical bonds, with the following general formula:

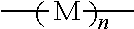

Where n is the number of repeating units, and n is greater than 10. The metal atom M is one or more of the transition metals. The metal atom in the main chain is connected to the ligand through a coordination bond.

In some embodiments, the chemical structure of the main chain is as follows:

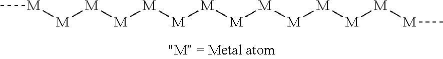

In some embodiments, the metal atom M is one or more of chromium, manganese, iron, cobalt, nickel, copper, rhodium, palladium, silver, iridium, platinum, and gold. In some embodiments, the metal atom M is one of nickel, rhodium, and palladium.

In some embodiments, the number-average molecular weight of the polymer is more than 3000.

In some embodiments, the ligand is one or more functional groups selected from pyridyl, naphthyridyl, amino, hydroxyl, phenyl, sulfhydryl, carboxyl, conjugated double bond, and phosphino groups.

In some embodiments, the ligand is pyridyl or amino, and the chemical structure of the polymer is as follows:

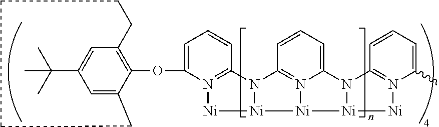

where n is the number of repeating units, and n is greater than 10.

The present disclosure also provides a method for preparing the metal-backboned polymer, comprising the following steps:
(S1) synthesis of the ligand: connecting polymer monomers through a polymerization reaction to obtain ligand units, and then connecting multiple ligand units to a template compound through a coupling reaction to obtain a ligand.
(S2) synthesis of the metal-backboned polymer: heating the ligands synthesized in step (S1) with a metal salt compound to perform a metallization reaction, to obtain the metal-backboned polymer.

In some embodiments, the ligand is pyridyl, in step S1, the polymer monomers are aminopyridine and halogenated aminopyridine.

In some embodiments, the aminopyridine is 2-aminopyridine. The halogenated aminopyridine is one of 2-fluoro-6-aminopyridine, 2-bromo-6-aminopyridine, 2-chloro-6-aminopyridine, 2-iodo-6-aminopyridine, 2-bromo-4-alkyl-6-aminopyridine, 2-chloro-4-alkyl-6-aminopyridine, 2-fluoro-4-alkyl-6-aminopyridine, and 2-fluoro-4-alkyl-6-aminopyridine. In some embodiments, the halogenated aminopyridine is one of 2-bromo-6-aminopyridine, 2-chloro-6-aminopyridine, or 2-fluoro-6-aminopyridine.

In some embodiments, the ratio of aminopyridine to halogenated aminopyridine ranges from 1:6 to 1:80. In some embodiments, the ratio of aminopyridine to halogenated aminopyridine ranges from 1:8 to 1:16.

In some embodiments, the step (S1) further comprises the following steps:

Dissolving the polymer monomers in an organic solvent, then performing polymerization under N₂, with a catalysis of a palladium catalyst, an organophosphorus ligand, and a base, to obtain the ligand units.

Subsequently, dissolving calixarene, dibromopyridine, and a base in an organic solvent, then heating under N₂ to perform coupling and obtain a templated compound.

Subsequently, dissolving the ligand units and the templated compound in an organic solvent, then heating under N₂ with a catalysis of a palladium catalyst, an organophosphorus ligand, and a base catalyst to perform coupling and obtain the ligand.

In some embodiments, the ligand units are polyaminopyridine.

The organic solvent is one of toluene, pyridine, methylpyridine, dioxane, tetrahydrofuran, N, N-dimethylformamide, N-methylpyrrolidone, and xylene. In some embodiments, the organic solvent is one of toluene, pyridine, or 4-methylpyridine.

The palladium catalyst is one of tris(dibenzylideneacetone)dipalladium, palladium acetate, (2-dicyclohexylphosphino-3,6-dimethoxy-2′,4′,6-triisopropyl-1,1′-biphenyl)[2-(2-aminoethylphenyl)]palladium chloride, chloro(2-dicyclohexylphosphino-2″,6″-diisopropyl-1,1″-biphenyl)[2-(2-aminoethylphenyl)]palladium(II), and dichloro[1,1′-bis(diphenylphosphino)ferrocene]palladium. In some embodiments, the palladium catalyst is one of tris(dibenzylideneacetone)dipalladium, palladium acetate, and dichloro[1,1′-bis(diphenylphosphino)ferrocene]palladium.

The organophosphorus ligand is one of 1,3-bis(diphenylphosphino)propane, 1,1′-binaphthyridyl-2,2′-bis(diphenylphosphine), 2-dicyclohexylphosphino-2′,4′,6′-triisopropylbiphenyl, and dicyclohexyl[3,6-dimethoxy-2′,4′,6-triisopropyl[1,1′-biphenyl]-2-yl]phosphine. In some embodiments, the organophosphorus ligand is one of 1,3-bis(diphenylphosphino)propane, 1,1′-binaphthyridyl-2,2′-bis(diphenylphosphine), and 2-dicyclohexylphosphino-2′,4′,6′-triisopropylbiphenyl.

The base is one of potassium tert-butoxide, cesium carbonate, potassium carbonate, sodium tert-butoxide, diisopropylethylamine, sodium carbonate, and potassium carbonate. In some embodiments, the base is potassium tert-butoxide or cesium carbonate.

The calixarene is one of calix[4]arene, 4-alkylcalix[4]arene, and 4-sulfonylcalix[4]arene. In some embodiments, the calixarene is tert-butylcalix[4]arene.

The dibromopyridine is one of 2,6-dibromopyridine, 2,6-dichloropyridine, 2-bromo-6-chloropyridine, 2,6-difluoropyridine, 2-fluoro-6-chloropyridine, and 2-fluoro-6-bromopyridine.

In some embodiments, in step (S2), the metal salt compound is one of acetate, chloride, bromide, sulfate, and trifluoroacetate of an alkali metal.

In some embodiments, the mass ratio of the ligand synthesized in step S1 to the metal salt compound ranges from 1:1 to 1:5. In some embodiments, the mass ratio of the ligand synthesized in step S1 to the metal salt compound ranges from 1:1 to 1:4.

In some embodiments, the metallization reaction in step S2 is performed in the presence of an organic solvent, and the organic solvent is one of dimethyl sulfoxide, naphthalene, and N-methylpyrrolidone.

The invention also provides the use of metal-backboned polymer. The metal-backboned polymer is used to prepare photoelectric materials, biomedical materials, or superconducting materials.

The present disclosure has the following beneficial effects:
(1) The present disclosure proposes and synthesizes a new polymer whose molecular main chain consists of metal atoms connected by chemical bonds.
(2) The preparation method is simple and efficient. By adjusting the ratio of aminopyridine to halogenated aminopyridine and the type of metal atoms, the metal-backboned polymers with the main chain composed of different metals and different lengths can be obtained, thus developing a new avenue to design new functional polymers in the future.

### BRIEF DESCRIPTION OF THE DRAWINGS

FIG. 1 is a diagram of matrix-assisted laser desorption/ionization time-of-flight mass spectrometry (MALDI-TOF MS) of the metal-backboned polymer in the present disclosure.

FIG. 2 is a diagram of the extended X-ray absorption fine structure (EXAFS) of the metal-backboned polymer in the present disclosure.

FIG. 3 is a diagram of the ultraviolet-visible absorption spectrum of the metal-backboned polymer in the present disclosure.

### DETAILED DESCRIPTION

The present disclosure will be described in detail with reference to the drawings and embodiments.

### Example 1

A metal-backboned polymer is prepared, and its preparation method includes the following steps:

### (1) Synthesis of the Ligand

a. Synthesis of Polyaminopyridine Ligand Units

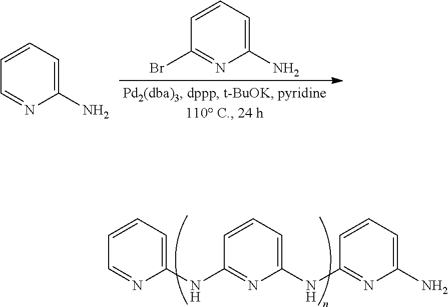

To toluene (50 mL), 2-aminopyridine (1.00 g, 10.63 mmol) and 2-amino-6-bromopyridine (14.70 g, 85.04 mmol) are added. Tris(dibenzylideneacetone)dipalladium (366 mg, 0.39 mmol), 1,3-bis(diphenylphosphino)propane (327 mg, 0.78 mmol), and potassium tert-butoxide (14.31 g, 127.56 mmol) are quickly added under N₂, stirred at 120° C. for 8 hours. Vacuum distillation is performed to remove the solvent, and the mixture is filtered to obtain a filter cake. The filter cake is washed with water and then ethanol, and dried to obtain a dark yellow powder (4.67 g) in 68% yield.

The data of the proton NMR spectrum and infrared spectrum are as follows:

¹H NMR (400 MHz, DMSO-d6, ppm): δ 9.35 (s, —NH—), 9.11-8.96 (m, —NH—), 8.78 (s, —NH—), 8.26-8.20 (m, Py-H), 7.94 (d, Py-H), 7.69-7.59 (m, Py-H), 7.59-7.41 (m, Py-H), 7.38-7.16 (m, Py-H), 7.13-7.07 (m, Py-H), 6.99-6.94 (m, Py-H), 6.89-6.81 (m, Py-H), 5.98 (d, Py-H), 5.62 (m, —NH₂).

FTIR (KBr, cm⁻¹): 3477, 3395, 3197, 3021, 1603, 1575, 1507, 1422, 1249, 1152, 987, 876, 776, 721, 615, 512.

The mass spectrometry data are as follows: the theoretical value of Mass Spectrometry (MALDI-TOF, m/z) for C₅ₙH₄ₙ₊₃N₂ₙ [M+H]⁺ (n) is 371.1 (4), 463.2 (5), 555.2 (6), 647.3 (7), 739.3 (8), 831.4 (9), 923.4 (10), and the measured value is 371.1, 463.1, 555.2, 647.2, 739.3, 831.3, 923.4.

b. Synthesis of the Template Compound

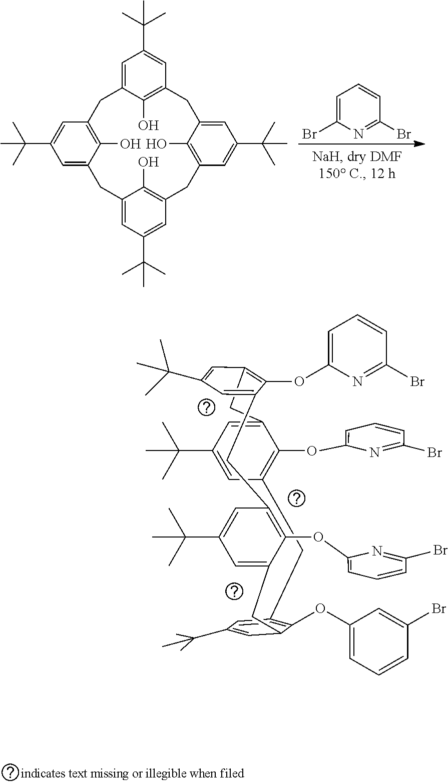

To a stirred dry N,N-dimethylformamide (150 mL) suspension of NaH (3.12 g, 60% suspension in paraffin liquid, 0.078 mol, 10.00 eq), 4-tert-butylcalix[4]arene (5.00 g, 0.008 mol, 1.00 eq) is slowly added under N₂, and the mixture is stirred at 50° C. for 30 minutes, then 2,6-dibromopyridine (29.13 g, 0.123 mol, 16.00 eq) is added, and the reaction is performed under reflux for 12 hours. After the solution is cooled, anhydrous ethanol (10 mL) is slowly added to quench the reaction. The solvent is removed by vacuum distillation, and the residue is filtered to obtain a filter cake. The filter cake is washed with ethanol and then methanol, extracted with acetone, and recrystallized from dichloromethane/methanol to obtain a white solid powder (3.41) g in 34% yield. The data of its proton NMR, carbon NMR, and infrared spectra are as follows:

¹H NMR (400 MHz, CDCl₃, ppm): δ 7.60 (dd, J=8.2, 7.5 Hz, 4H), 7.37 (dd, J=8.2, 0.7 Hz, 4H), 7.08 (dd, J=7.5, 0.6 Hz, 4H), 7.06 (s, 8H), 3.78 (d, J=13.0 Hz, 4H), 3.16 (d, J=13.0 Hz, 4H), 1.18 (s, 36H).

¹³C NMR (100 MHz, CDCl₃, ppm): δ 164.2, 147.2, 145.6, 140.8, 138.5, 133.9, 125.6, 121.1, 110.4, 34.2, 31.4, 31.1.

FTIR (KBr, cm⁻¹): 3077, 3049, 2962, 2933, 2903, 2866, 1577, 1557, 1480, 1429, 1405, 1362, 1301, 1283, 1261, 1236, 1192, 1157, 1137, 1118, 1076, 983, 924, 892, 879, 871, 821, 785, 740, 724, 670, 641, 540, 442.

The theoretical value of high-resolution mass spectrometry for C₆₄H₆₄Br₄N₄O₄ [M+H]⁺ is 1273.1706, and the measured value is 1273.1714.

c. Synthesis of the Ligand

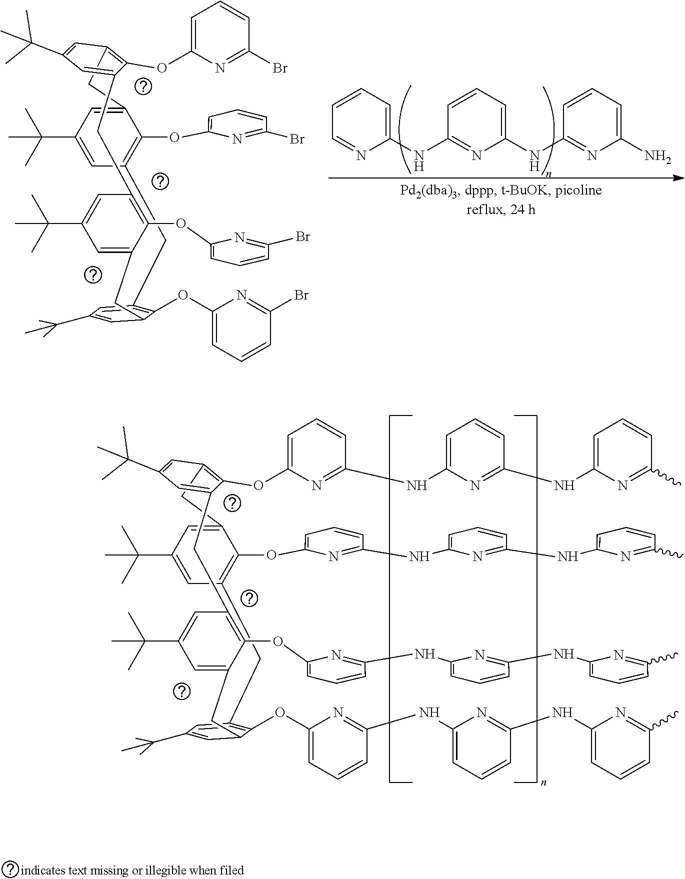

The polyaminopyridine (3.41 g) synthesized in step (a) and the template compound bromopyridine calixarene (400 mg, 0.31 mmol) synthesized in step (b) are dissolved in 4-methylpyridine (60 mL). Tris(dibenzylideneacetone)dipalladium (14.00 mg, 0.02 mmol), 1,3-bis(diphenylphosphino)propane (13.00 mg, 0.03 mmol), and potassium tert-butoxide (278 mg, 2.48 mmol) are rapidly added under N₂, and the reaction is performed under reflux for 12 hours. After the reaction, the mixture is poured into ice water, and filtered to obtain a filter cake. The filter cake is washed with ethanol and then dichloromethane, and dried to obtain a brown-gray crude product (2.12 g), which is used directly for the next reaction. The mass spectrometry data are as follows:

The theoretical value of Mass spectrum (MALDI-TOF, m/z) for C₅₄₊₅ₙH₆₀₊₄ₙN₂ₙO₄: [M+Na]⁺ (n)=2821.3 (24), 2913.3 (25), 3005.3 (26), 3097.4 (27), 3190.4 (28), 3282.5 (29), 3374.5 (30), 3466.5 (31), 3558.6 (32), 3651.1 (33), 3743.3 (34), 3835.3 (35), 3927.7 (36), and the measured value is 2821.8, 2913.9, 3005.9, 3098.0, 3190.1, 3282.1, 3374.2, 3466.2, 3558.3, 3650.8, 3743.1, 3835.0, 3927.4.

### (2) Synthesis of the Metal-Backboned Polymer

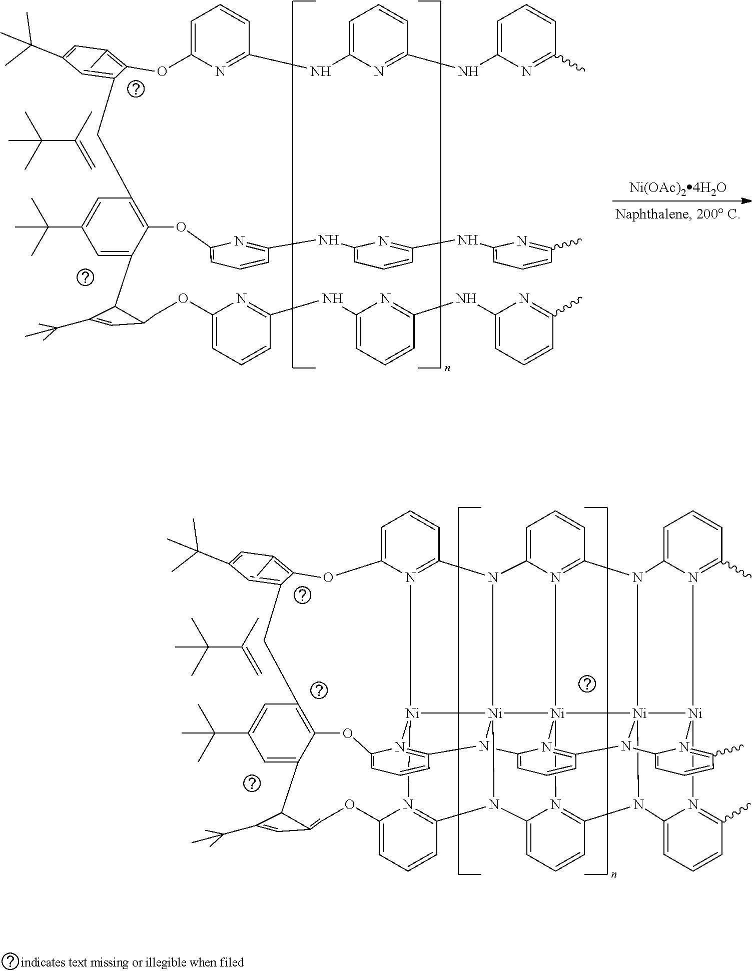

The ligand synthesized in step (1) (40 mg), nickel acetate tetrahydrate (80 mg), and naphthalene (10 g) are mixed and stirred at 200° C. for 24 hours under N₂. After the mixture is cooled to 80° C., petroleum ether is added, and the naphthalene is removed by filtration. The filter cake is washed with dichloromethane to obtain a filtrate. The solvent is removed from the filtrate to obtain the metal-backboned polymer (14.4 mg) in 28% yield.

The infrared spectrum data are as follows:

FTIR (KBr, cm⁻¹): 2953, 2923, 2852, 1599, 1583, 1557, 1410, 1307, 1257, 1226, 1194, 1153, 1126, 1012, 842, 767, 722, 557.

The mass spectrometry data are as follows:

The theoretical value of Mass spectrometry (MALDI-TOF, m/z) [M]⁺ is 3516.4, 3609.5, 3700.5, 3792.5, 3884.6, 3976.6, 3997.4, 4089.5, 4182.5, 4274.5, 4479.3, 4571.4, and the measured value is 3515.9, 3609.0, 3700.0, 3792.1, 3884.1, 3976.1, 3996.9, 4089.0, 4182.1, 4274.1, 4479.0, 4571.1.

### Example 2

A metal-backboned polymer is prepared, and its preparation method includes the following steps:

### (1) Synthesis of the Ligand

a. Synthesis of Polyaminopyridine Ligand Units

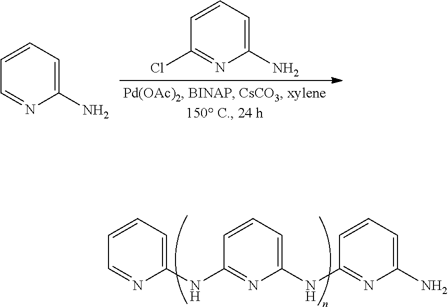

To p-xylene (80 mL), 2-aminopyridine (1.00 g, 10.63 mmol) and 2-amino-6-chloropyridine (13.67 g, 106.30 mmol) are added and dissolved. Palladium acetate (129 mg, 0.39 mmol), 1,1′-binaphthyridyl-2,2′-bisdiphenylphosphine (485.69 mg, 0.78 mmol), and cesium carbonate (31.17 g, 127.56 mmol) are rapidly added under N₂, and the mixture is stirred at 150° C. for 24 hours. The solvent is removed by vacuum distillation, and the mixture is ultrasonicated with water and filtered to obtain a filter cake. The filter cake is washed with water and then ethanol, and dried to obtain a deep yellow powder (4.87 g) in 71% yield.

The data of proton NMR spectrum and infrared spectrum are as follows:

¹H NMR (400 MHz, DMSO-d6, ppm): δ 9.35 (s, —NH—), 9.11-8.96 (m, —NH—), 8.78 (s, —NH—), 8.26-8.20 (m, Py-H), 7.94 (d, Py-H), 7.69-7.59 (m, Py-H), 7.59-7.41 (m, Py-H), 7.38-7.16 (m, Py-H), 7.13-7.07 (m, Py-H), 6.99-6.94 (m, Py-H), 6.89-6.81 (m, Py-H), 5.98 (d, Py-H), 5.62 (m, —NH₂).

FTIR (KBr, cm⁻¹): 3477, 3395, 3197, 3021, 1603, 1575, 1507, 1422, 1249, 1152, 987, 876, 776, 721, 615, 512.

The mass spectrometry data are as follows:

The theoretical value of Mass spectrometry (MALDI-TOF, m/z) for C₅ₙH₄ₙ₊₃N₂ₙ [M+H]⁺ (n) is 463.2 (5), 555.2 (6), 647.3 (7), 739.3 (8), 831.4 (9), 923.4 (10), 1015.6 (11), and the measured value is 463.1, 555.2, 647.2, 739.3, 831.3, 923.4, 1015.5.

b. Synthesis of the Template Compound

The synthesis of the template compound follows the same procedure as in step (1) b of Example 1.

c. Synthesis of the Ligand

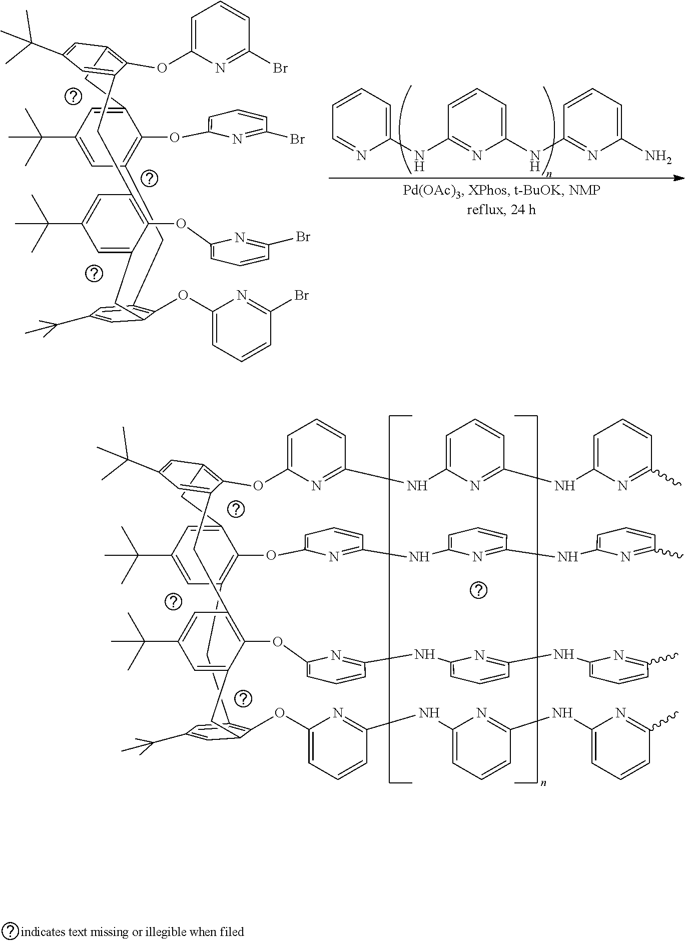

The polyaminopyridine (3.41 g) synthesized in step (a) and the template compound bromopyridine calixarene (400 mg, 0.31 mmol) synthesized in step (b) are added to N-methylpyrrolidone (50 mL) and dissolved. Palladium acetate (6.85 mg, 0.03 mmol), 1,3-bis(diphenylphosphino)propane (30.04 mg, 0.06 mmol), and potassium tert-butoxide (278 mg, 2.48 mmol) are rapidly added under N₂, and the reaction is performed under reflux for 24 hours. After the reaction, the mixture is poured into ice water and filtered to obtain a filter cake. The filter cake is washed with ethanol and then dichloromethane, and dried to obtain a brown-gray crude product (2.51 g), which is used directly in the next reaction.

The mass spectrometry data are as follows:

The theoretical value of Mass spectrometry (MALDI-TOF, m/z) for C₅₄₊₅ₙH₆₀₊₄ₙN₂ₙO₄Na [M+Na]⁺ (n) is 2913.3 (25), 3005.3 (26), 3097.4 (27), 3190.4 (28), 3282.5 (29), 3374.5 (30), 3466.5 (31), 3558.6 (32), 3651.1 (33), 3743.3 (34), 3835.3 (35), 3927.7 (36), 4019.9 (37), and the measured value is 2913.9, 3005.9, 3098.0, 3190.1, 3282.1, 3374.2, 3466.2, 3558.3, 3650.8, 3743.1, 3835.0, 3927.4, 4019.9.

### (2) Synthesis of the Metal-Backboned Polymer

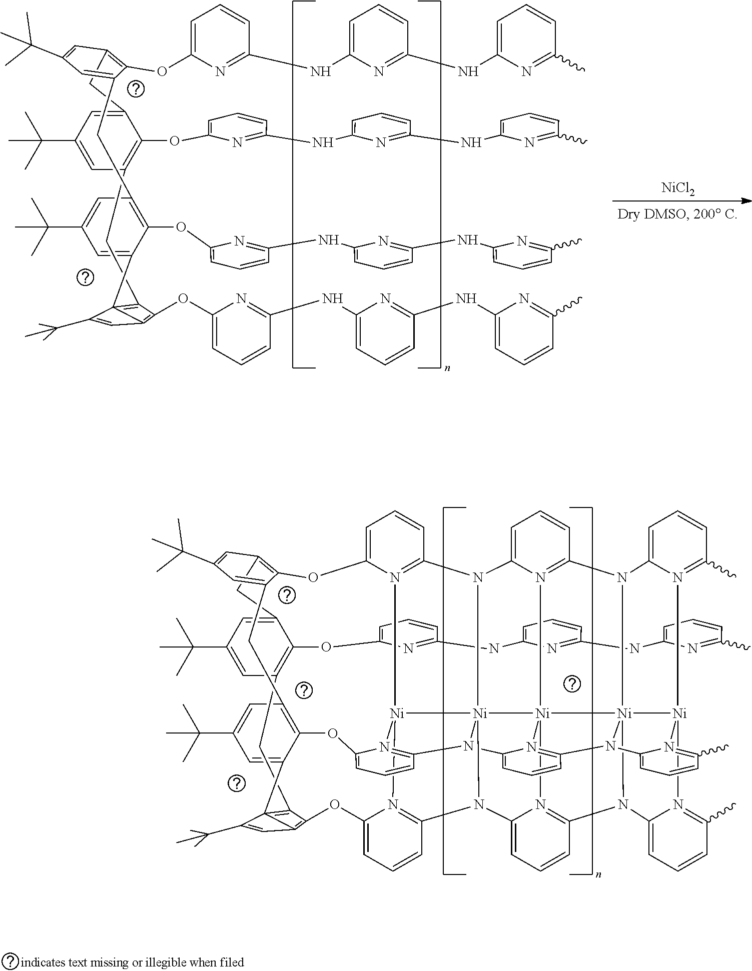

To anhydrous dimethyl sulfoxide (40 mL), the ligand (60 mg) synthesized in step (1) and nickel chloride (83 mg) are added. The mixture is stirred at 180° C. under N₂ for 12 hours. After the reaction, the solvent is removed by vacuum distillation. The residue is dissolved in dichloromethane, and filtered to obtain the metal-backboned polymer (27 mg) in 35% yield after removing the solvent.

The infrared spectrum data are as follows:

FTIR (KBr, cm⁻¹): 2953, 2923, 2852, 1599, 1583, 1557, 1410, 1307, 1257, 1226, 1194, 1153, 1126, 1012, 842, 767, 722, 557.

The mass spectrometry data are as follows:

The theoretical values of Mass spectrometry (MALDI-TOF, m/z) are 3218.5, 3310.6, 3402.6, 3494.6, 3516.4, 3609.5, 3700.5, 3792.5, 3884.6, 3976.6, 3997.4, 4089.5, 4182.5, 4274.5, 4479.3, 4571.4, 4663.5, 4755.5, and the measured values are 3218.0, 3310.1, 3402.1, 3494.2, 3515.9; 3609.0; 3700.0, 3792.1, 3884.1, 3976.1, 3996.9, 4089.0, 4182.1, 4274.1, 4479.0, 4571.1, 4663.2, 4755.2.

### Example 3

A metal-backboned polymer is prepared, and its preparation method includes the following steps:

### (1) Synthesis of the Ligand

a. Synthesis of Polyaminopyridine Ligand Units

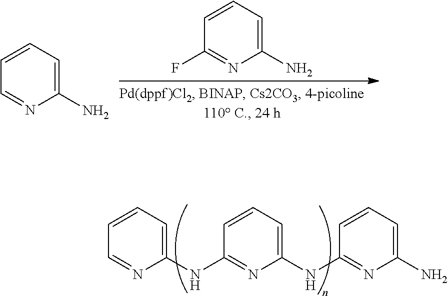

To 4-methylpyridine (100 mL), 2-aminopyridine (1.00 g, 10.63 mmol) and 2-amino-6-fluoropyridine (32.44 g, 148.82 mmol) are added, dichloro[1,1′-bis(diphenylphosphino)ferrocene]palladium (399 mg, 0.39 mmol), 1,1′-binaphthyridyl-2,2′-bisdiphenylphosphine (679 mg, 1.09 mmol), and cesium carbonate (43.66 g, 133.94 mmol) are rapidly added under N₂, and the mixture is stirred at 150° C. for 8 hours. After the reaction, the solvent is removed by vacuum distillation, and the residue is filtered to obtain a filter cake. The filter cake is washed with water and then ethanol, and dried to obtain a deep yellow powder (4.67 g) in 68% yield.

The data of proton NMR spectrum and infrared spectrum are as follows:

¹H NMR (400 MHz, DMSO-d6, ppm): δ 9.35 (s, —NH—), 9.11-8.96 (m, —NH—), 8.78 (s, —NH—), 8.26-8.20 (m, Py-H), 7.94 (d, Py-H), 7.69-7.59 (m, Py-H), 7.59-7.41 (m, Py-H), 7.38-7.16 (m, Py-H), 7.13-7.07 (m, Py-H), 6.99-6.94 (m, Py-H), 6.89-6.81 (m, Py-H), 5.98 (d, Py-H), 5.62 (m, —NH₂).

FTIR (KBr, cm⁻¹): 3477, 3395, 3197, 3021, 1603, 1575, 1507, 1422, 1249, 1152, 987, 876, 776, 721, 615, 512.

The mass spectrometry data are as follows:

The theoretical value of Mass spectrometry (MALDI-TOF, m/z) for C₅ₙH₄ₙ₊₃N₂ₙ [M+H]⁺ (n) is 463.2 (5), 555.2 (6), 647.3 (7), 739.3 (8), 831.4 (9), 923.4 (10), 1015.6 (11), 1107.6 (12), and the measured value is 463.1, 555.2, 647.2, 739.3, 831.3, 923.4, 1015.5, 1107.6.

b. Synthesis of the Template Compound

The synthesis of the template compound follows the same procedure as in step (1) b of Example 1.

c. Synthesis of the Ligand

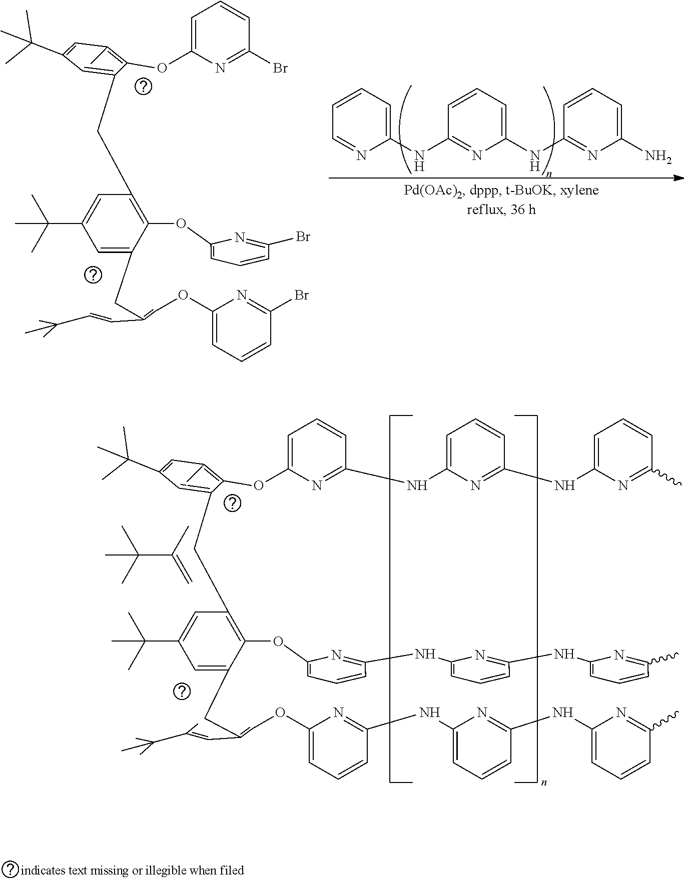

To xylene (100 mL), the polyaminopyridine synthesized in step a (5.32 g) and the bromopyridine calixarene synthesized in step b (400 mg, 0.31 mmol) are added. Palladium acetate (13.72 mg, 0.06 mmol), 1,3-bis(diphenylphosphino)propane (13.00 mg, 0.03 mmol), and potassium tert-butoxide (278 mg, 2.48 mmol) are rapidly added under N₂, then the reaction is performed under reflux for 36 hours. After the reaction, the mixture is poured into ice water, and filtered to obtain a filter cake. The filter cake is washed with ethanol and then dichloromethane, and dried to obtain a brown-gray crude product (2.35 g), which is used directly for the next reaction.

The mass spectrometry data are as follows:

The theoretical values of Mass spectrometry (MALDI-TOF, m/z) for C₅₄₊₅ₙH₆₀₊₄ₙN₂ₙO₄Na [M+Na]⁺ (n) are 2913.3 (25), 3005.3 (26), 3097.4 (27), 3190.4 (28), 3282.5 (29), 3374.5 (30), 3466.5 (31), 3558.6 (32), 3651.1 (33), 3743.3 (34), 3835.3 (35), 3927.7 (36), 4019.9 (37), 4112.2 (38), 4202.8 (39), 4295.8 (40), and the measured value are 2913.9, 3005.9, 3098.0, 3190.1, 3282.1, 3374.2, 3466.2, 3558.3, 3650.8, 3743.1, 3835.0, 3927.4, 4019.9, 4111.9, 4202.6, 4295.6.

### (2) Synthesis of the Metal-Backboned Polymer

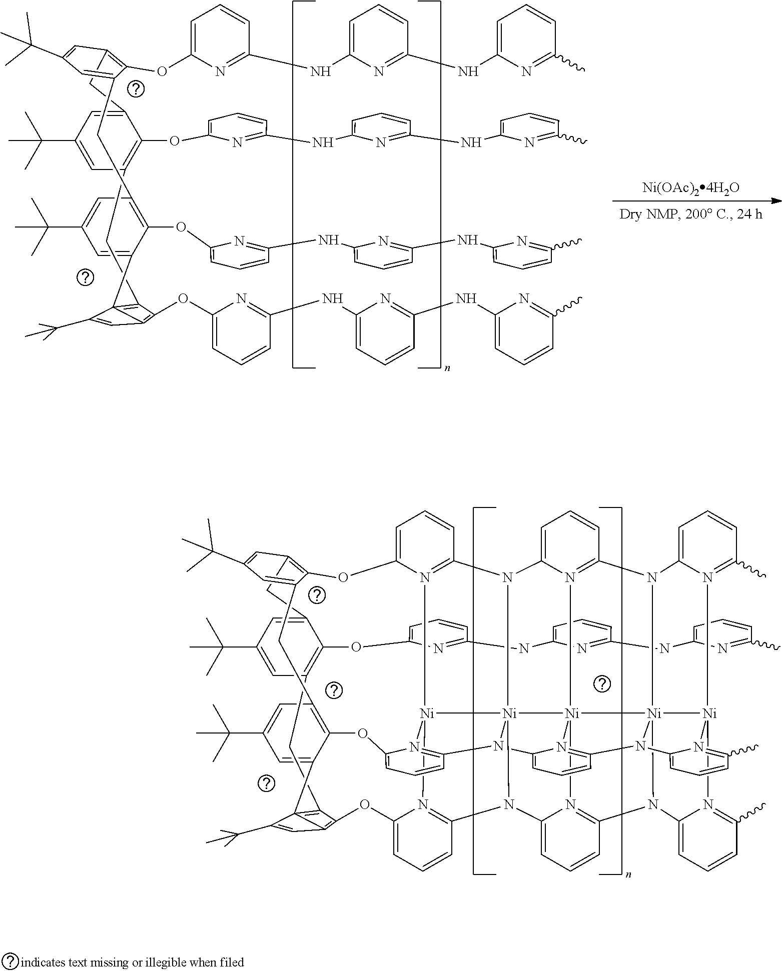

To 20 mL of anhydrous dimethyl sulfoxide, the ligand synthesized in step (1) (40 mg) and nickel acetate tetrahydrate (120 mg) are added. The mixture is stirred under N₂ at 200° C. for 24 hours. After the reaction, the solvent is removed by vacuum distillation. The residue is dissolved in dichloromethane, and the solution is filtered to remove the solvent to obtain the metal-backboned polymer (18.51 mg) in 36% yield.

The infrared spectrum data are as follows:

FTIR (KBr, cm⁻¹): 2953, 2923, 2852, 1599, 1583, 1557, 1410, 1307, 1257, 1226, 1194, 1153, 1126, 1012, 842, 767, 722, 557.

The mass spectrometry data are as follows:

The theoretical value of Mass spectrometry (MALDI-TOF, m/z) [M]⁺ are 3516.4, 3609.5, 3700.5, 3792.5, 3884.6, 3976.6, 3997.4, 4089.5, 4182.5, 4274.5, 4479.3, 4571.4, 4755.5, 4961.4, 5053.4, 5145.5, 5386.1, and the measured value are 3515.9, 3609.0, 3700.0, 3792.1, 3884.1, 3976.1, 3996.9, 4089.0, 4182.1, 4274.1, 4479.0, 4571.1, 4755.2, 4961.1, 5053.1, 5145.2, 5385.8.

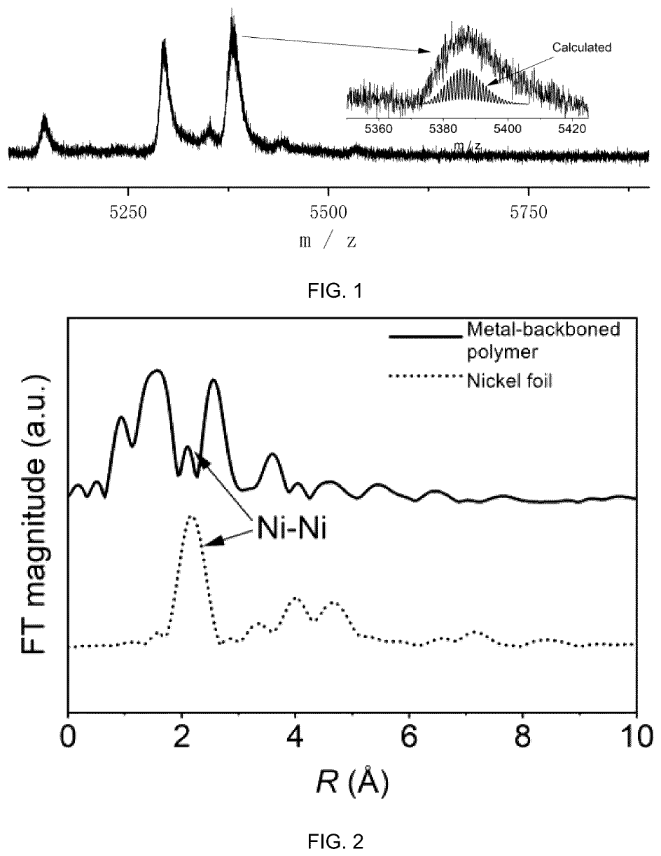

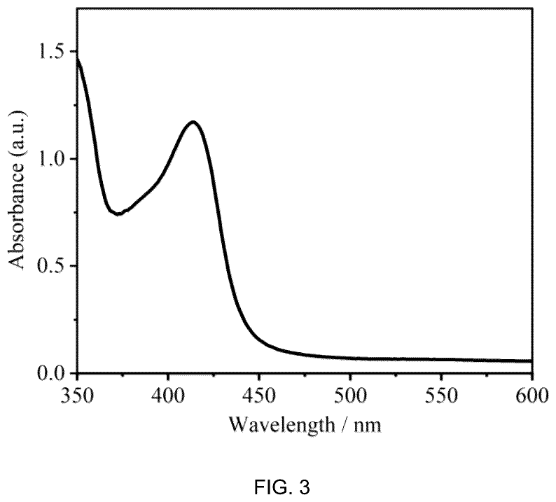

Upon detection, the synthesized metal-backboned polymer has a structure shown in the above formula, and its molecular weight can reach over 5000 (FIG. 1, Example 3). As shown in FIG. 2 (Example 1), the extended X-ray absorption fine structure (EXAFS) spectrum of the metal-backboned polymer shows an absorption peak at 2.11 Å, which is consistent with the absorption peak of reference nickel foil at 2.16 Å. This indicates the existence of Ni—Ni metal bonds in the synthesized metal-backboned polymer. Additionally, its UV-vis absorption spectrum in dichloromethane shows an absorption band in the wavelength range of 370-450 nm, with a maximum absorption wavelength of 414 nm (FIG. 3, Example 2).

The molecular structure was tested using nuclear magnetic resonance (NMR) with deuterated dimethyl sulfoxide (DMSO-d6) as the solvent. The molecular weight was measured using a Bruker McriOTOF11 polymer mass spectrometer and an AB SCIEX 5800 Matrix-Assisted Laser Desorption/Ionization Time-of-Flight (MALDI-TOF) mass spectrometer (with trans-2-[3-(4-tert-Butylphenyl)-2-methyl-2-propenylidene]malononitrile as the matrix and sodium trifluoroacetate as the sodium salt). X-ray absorption spectrum was tested using the 1W1B beamline of the Beijing Synchrotron Radiation Facility (BSRF). The UV-Vis absorption spectrum was tested using a Perkin-Elmer Lambda750 UV-Vis spectrophotometer.

The main chain of the synthesized metal-backboned polymer contains metal atoms linked by chemical bonds. The metal-backboned polymer may exhibit unique properties in aspects such as light, heat, force, sound, electricity, and magnetism, and thus will be applied as photoelectric materials, biomedical materials, superconducting materials, etc.

The examples set forth above are provided to give those of ordinary skill in the art with a complete disclosure and description of how to make and use the claimed embodiments, and are not intended to limit the scope of what is disclosed herein. Modifications that are obvious to persons of skill in the art are intended to be within the scope of the following claims.

1. A metal-backboned polymer comprising a main chain and at least one ligand, wherein the main chain comprises metal atoms connected by chemical bonds, with the following general formula: 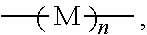
wherein n is a number of repeating units, and n is greater than 10;
M is a metal atom and is one or more of transition metal elements; and
the metal atom in the main chain is connected to a ligand via a coordination bond.

2. The polymer of claim 1, wherein M is one or more of chromium,
manganese, iron, cobalt, nickel, copper, rhodium, palladium, silver, iridium, platinum, and gold;
a number-average molecular weight of the polymer is more than 3000;
the ligand is one or more of pyridyl, naphthyridyl, amino, hydroxyl, phenyl, sulfhydryl, carboxyl, conjugated double bond, and phosphino groups.

3. The polymer of claim 2, wherein the ligand is pyridyl or amino.

4. The polymer of claim 3, wherein the polymer has the following formula: 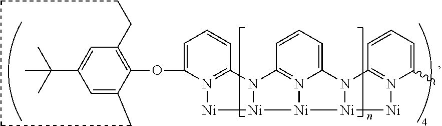
wherein n is a number of repeating units, and n is greater than 10.

5. A method for preparing the polymer of claim 1, comprising:
(S1) synthesis of a ligand: connecting polymer monomers through a polymerization reaction to obtain ligand units, and then connecting multiple ligand units to a template compound through a coupling reaction to obtain a ligand;
(S2) synthesis of the metal-backboned polymer: heating the ligands synthesized in step (S1) with a metal salt compound to perform a metallization reaction, to obtain the metal-backboned polymer.

6. The method of claim 5, wherein the ligand is pyridyl, in step (S1), the polymer monomers are aminopyridine and halogenated aminopyridine;
the aminopyridine is 2-aminopyridine;
the halogenated aminopyridine is one of 2-fluoro-6-aminopyridine, 2-bromo-6-aminopyridine, 2-chloro-6-aminopyridine, 2-iodo-6-aminopyridine, 2-bromo-4-alkyl-6-aminopyridine, 2-chloro-4-alkyl-6-aminopyridine, 2-fluoro-4-alkyl-6-aminopyridine, and 2-fluoro-4-alkyl-6-aminopyridine; and
the ratio of aminopyridine to halogenated aminopyridine ranges from 1:6 to 1:80.

7. The method of claim 5, wherein the step (S1) further comprises the following steps: dissolving the polymer monomers in an organic solvent, then performing a polymerization under N2, with a catalysis of a palladium catalyst, an organophosphorus ligand, and a base, to obtain the ligand units; subsequently, dissolving calixarene, dibromopyridine, and a base in an organic solvent, then heating under N2 to perform coupling and obtain a templated compound; subsequently, dissolving the ligand units and the templated compound in an organic solvent, then heating under N2 with a catalysis of a palladium catalyst, an organophosphorus ligand, and a base catalyst to perform coupling and obtain the ligand.

8. The method of claim 7, wherein the ligand units are polyaminopyridine;
the organic solvent is one of toluene, pyridine, methylpyridine, dioxane, tetrahydrofuran, N, N-dimethylformamide, N-methylpyrrolidone, and xylene;
the palladium catalyst is one of tris(dibenzylideneacetone)dipalladium, palladium acetate, (2-dicyclohexylphosphino-3,6-dimethoxy-2′,4′,6-triisopropyl-1,1′-biphenyl)[2-(2-aminoethylphenyl)]palladium chloride, chloro(2-dicyclohexylphosphino-2″,6″-diisopropyl-1,1″-biphenyl) [2-(2-aminoethylphenyl)]palladium(II), and dichloro[1,1′-bis(diphenylphosphino)ferrocene]palladium;
the organophosphorus ligand is one of 1,3-bis(diphenylphosphino)propane, 1,1′-binaphthyridyl-2,2′-bis(diphenylphosphine), 2-dicyclohexylphosphino-2′,4′,6′-triisopropylbiphenyl, and dicyclohexyl[3,6-dimethoxy-2′,4′,6-triisopropyl[1,1′-biphenyl]-2-yl]phosphine;
the base is one of potassium tert-butoxide, cesium carbonate, potassium carbonate, sodium tert-butoxide, diisopropylethylamine, sodium carbonate, and potassium carbonate;
the calixarene is one of calix[4]arene, 4-alkylcalix[4]arene, and 4-sulfonylcalix[4]arene; and
the dibromopyridine is one of 2,6-dibromopyridine, 2,6-dichloropyridine, 2-bromo-6-chloropyridine, 2,6-difluoropyridine, 2-fluoro-6-chloropyridine, and 2-fluoro-6-bromopyridine.

9. The method of claim 5, wherein in step (S2), the metal salt compound is one of acetate, chloride, bromide, sulfate, and trifluoroacetate of an alkali metal; the weight ratio of the ligand synthesized in step (S1) to the metal salt compound ranges from 1:1 to 1:5; the metallization reaction is performed in the presence of an organic solvent, and the organic solvent is one of dimethyl sulfoxide, naphthalene, and N-methylpyrrolidone.

10. Use of the polymer of claim 1, wherein the polymer is used to prepare photoelectric materials, biomedical materials, or superconducting materials.
